(19) United States
(12) Patent Application Publication
(10) Pub. No.: US 2013/0032174 A1
(43) Pub. Date: Feb. 7, 2013

(54) CLEANING SYSTEM FOR PHOTOMASK UNIT AND METHOD FOR CLEANING PHOTOMASK UNIT

(71) Applicant: Tian-Xing HUANG, Tainan City (TW)

(72) Inventor: Tian-Xing HUANG, Tainan City (TW)

(21) Appl. No.: 13/566,729

(22) Filed: Aug. 3, 2012

(30) Foreign Application Priority Data
Aug. 5, 2011 (TW) 100127956

(51) Int. Cl. B08B 5/00; F17D 1/00; B08B 7/04

(52) U.S. Cl. 134/19; 134/105; 134/34; 137/596

(57) ABSTRACT

A cleaning system for a photomask unit is disclosed. The photomask unit defines an inner chamber and includes a photomask, a pellicle frame, a diaphragm-like pellicle film, and a ventilation port. The cleaning system includes: a housing defining an outer chamber; and a reduced-pressure generating unit disposed to intermittently generate a reduced-pressure zone in the outer chamber and in proximity to the photomask unit such that a pressure differential is generated between the inner chamber and the reduced-pressure zone to cause a central film portion of the diaphragm-like pellicle film to move toward or away from a central pattern region of the photomask so as to permit the cleaning gas to flow out of or into the ventilation port alternately.

### CROSS-REFERENCE TO RELATED APPLICATION

This application claims priority to Taiwanese application no. 100127956, filed on Aug. 5, 2011.

### BACKGROUND OF THE INVENTION

1. Field of the Invention

This invention relates to a cleaning system, more particularly to a cleaning system for a photomask unit and a method for cleaning the photomask unit.

2. Description of the Related Art

In a photolithography process for forming integrated circuits on a semiconductor device, a photomask is normally used to transfer a mask pattern to a photosensitive layer under an exposure light. However, foreign substances may be formed on the photomask when the exposure light has a relatively short wavelength. In this case, the foreign substances on the photomask may be transferred to the semiconductor device so that the semiconductor device has undesired defects, thereby reducing the yield rate. Therefore, many efforts are focused on the cleaning of the photomask.

A method for cleaning a photomask is disclosed in US 2008/0251100 A1. The photomask has a pattern region protected by a pellicle unit. The pellicle unit has a pellicle frame mounted to the photomask to surround the pattern region, and a pellicle film having a periphery connected to one end of the pellicle frame opposite to the photomask. A chamber is defined between the photomask and the pellicle unit. The pellicle frame has a gas introducing hole and a gas discharging hole. When cleaning the photomask, a gaseous substituting substance is introduced into the chamber through the gas introducing hole to substitute foreign substances on the photomask, and the foreign substances are then discharged from the gas discharging hole. Thereafter, the photomask is irradiated with an ultraviolet ray while introducing air, a nitrogen gas or a rare gas into the chamber so as to degrade and gasify the substituted substances. Finally, the gaseous substituted substances are discharged through the gas discharging hole.

The photomask and the pellicle unit may also be disposed as those disclosed in U.S. Pat. No. 7,205,074 B2.

### SUMMARY OF THE INVENTION

An object of the present invention is to provide a cleaning system and a method for cleaning a photomask unit to effectively clean the photomask unit.

According to the first aspect of this invention, a cleaning system for a photomask unit is provided. The photomask unit includes: a photomask having an inner major surface which has a central pattern region to be cleaned and an abutment region surrounding the central pattern region, and which defines a centerline to that the central pattern region is normal; a pellicle frame which surrounds the centerline and which extends from the abutment region along the centerline to terminate at a mounting end so as to define an inner chamber; a diaphragm-like pellicle film having a central film portion which extends in radial directions to terminate at a periphery that is connected to the mounting end, and which is configured to be movable toward or away from the central pattern region; and at least one ventilation port disposed in the pellicle frame to fluidly communicate with the inner chamber. The cleaning system includes: a housing defining an outer chamber configured to permit the photomask unit to be located therein, and having an inlet and an outlet to permit a cleaning gas to flow into and out of the outer chamber, respectively; and a reduced-pressure generating unit disposed to intermittently generate a reduced-pressure zone in the outer chamber and in proximity to the photomask unit such that a pressure differential is generated between the inner chamber and the reduced-pressure zone to cause the central film portion to move toward or away from the central pattern region so as to permit the cleaning gas to flow out of or into the ventilation port alternately.

According to the second aspect of this invention, a method for cleaning a photomask unit is provided. The photomask unit includes: a photomask having an inner major surface which has a central pattern region to be cleaned, and which defines a centerline to that the central pattern region is normal; a pellicle frame extending from the photomask to surround the centerline and to terminate at a mounting end so as to define an inner chamber; a diaphragm-like pellicle film having a central film portion and a periphery that surrounds the central film portion and that is connected to the mounting end; and at least one ventilation port disposed in the pellicle frame to fluidly communicate with the inner chamber. The method includes: mounting the photomask unit in an outer chamber of a housing, the housing having an inlet and an outlet to permit a cleaning gas to flow into and out of the outer chamber respectively; and intermittently generating a reduced-pressure zone in the outer chamber and in proximity to the photomask unit such that a pressure differential is generated between the inner chamber and the reduced-pressure zone to cause the central film portion to move toward or away from the photomask so as to permit the cleaning gas to flow out of or into the ventilation port alternately. Accordingly, the cleaning gas can flow into and out of the inner chamber periodically.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a partially sectional view of the first preferred embodiment of a cleaning system for a photomask unit according to the present invention, in which a reduced-pressure generating unit of the cleaning system is in a standby mode;

FIG. 2 is a partial top view of FIG. 1, illustrating the photomask unit and the reduced-pressure generating unit of the cleaning system;

FIG. 3 is a flow diagram illustrating the first preferred embodiment of a method for cleaning the photomask unit according to this invention;

FIGS. 4 and 5 are views respectively similar to FIGS. 2 and 1 but illustrating the reduced-pressure generating unit in an operation mode;

FIG. 6 is a partial top view of the second preferred embodiment of a cleaning system for cleaning a photomask unit, in which a reduced-pressure generating unit is in an operation mode;

FIG. 7 is a partially sectional view of the third preferred embodiment of a cleaning system for a photomask unit according to the present invention, in which a reduced-pressure generating unit is in a standby mode;

FIG. 8 is a view similar to FIG. 7 but illustrating the reduced-pressure generating unit in an operation mode;

FIG. 9 is a partially sectional view of the fourth preferred embodiment of a cleaning system for a photomask unit according to the present invention, in which a reduced-pressure generating unit is in an operation mode;

FIG. 10 is a partially sectional view of the fifth preferred embodiment of a cleaning system for a photomask unit according to the present invention, in which each of a heating unit and a reduced-pressure generating unit is in a standby mode;

FIG. 11 is a view similar to FIG. 10 but illustrating both of the heating unit and the reduced-pressure generating unit in an operation mode;

FIG. 12 is a view similar to FIG. 11 but viewed from another side;

FIG. 13 is a partially sectional view of the sixth preferred embodiment of a cleaning system for a photomask unit according to the present invention, in which a reduced-pressure generating unit is in an operation mode;

FIG. 14 is a partially sectional view of the seventh preferred embodiment of a cleaning system for a photomask unit according to the present invention, illustrating a heating unit in an operation mode and a reduced-pressure generating unit in a standby mode;

FIG. 15 is a view similar to FIG. 14 but illustrating the heating unit in a standby mode and the reduced-pressure generating unit in an operation mode; and

FIG. 16 is a partially sectional view of the eighth preferred embodiment of a cleaning system for a photomask unit according to the present invention, illustrating a heating unit in a standby mode and a reduced-pressure generating unit in an operation mode.

### DETAILED DESCRIPTION OF THE PREFERRED EMBODIMENTS

Before the present invention is described in greater detail, it should be noted herein that like elements are denoted by the same reference numerals throughout the disclosure.

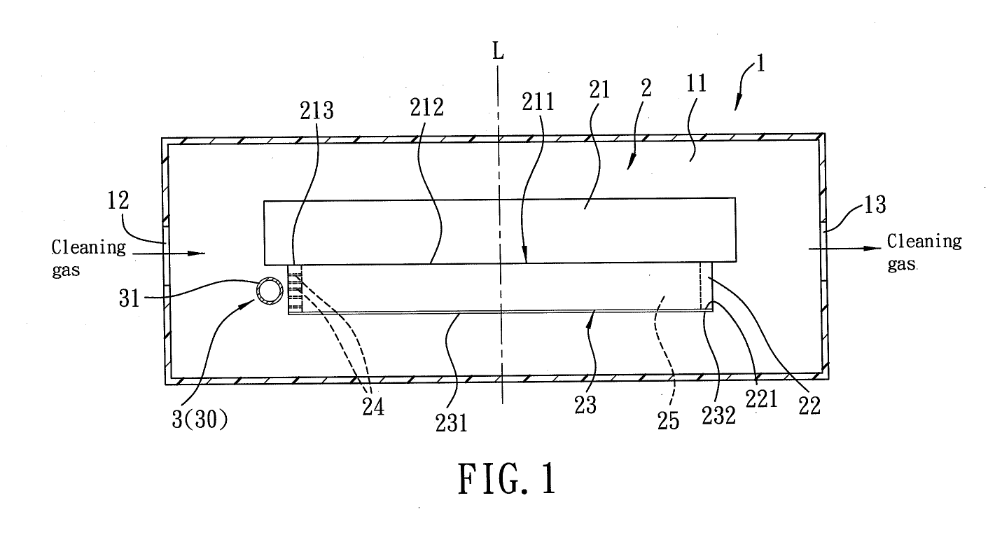

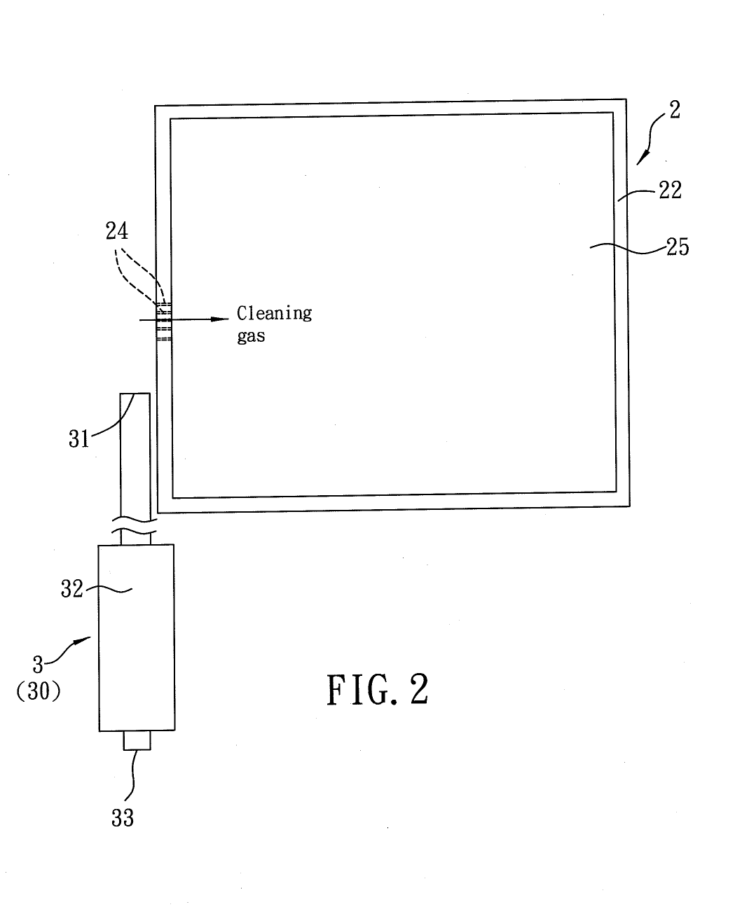

Referring to FIGS. 1 and 2, the first preferred embodiment of a cleaning system for cleaning a photomask unit 2 according to this invention comprises a housing 1 and a reduced-pressure generating unit 3.

The photomask unit 2 includes a photomask 21, a pellicle frame 22, a pellicle film 23, and at least one ventilation port 24. In this embodiment, the photomask unit 2 has a plurality of the ventilation ports 24 adjacent to one another (see FIG. 1) The photomask 21 has an inner major surface 211 which has a central pattern region 212 to be cleaned and an abutment region 213 surrounding the central pattern region 212. The inner major surface 211 defines a centerline (L) to which the central pattern region 212 is normal. The pellicle frame 22 surrounds the centerline (L) and extends from the abutment region 213 along the centerline (L) to terminate at a mounting end 221 so as to define an inner chamber 25. The diaphragm-like pellicle film 23 has a central film portion 231 which extends in radial directions to terminate at a periphery 232 that is connected to the mounting end 221. The central film portion 231 is configured to be movable toward or away from the central pattern region 212. The ventilation ports 24 are disposed in the pellicle frame 22 to fluidly communicate an outer chamber 11 with the inner chamber 25. The number of the ventilation ports 24 can be varied as long as the ventilation ports 24 can function to regulate the pressure inside the inner chamber 25.

The housing 1 defines the outer chamber 11, which is configured to permit the photomask unit 2 to be mounted therein, and has an inlet 12 and an outlet 13 to permit a cleaning gas to flow into and out of the outer chamber 11 therethrough, respectively. The housing 1 may be a mask package a reticle SMIF (standard mechanical interface) pod, a mask stock, a mask transfer interface pod, a buffer pod, or a housing inside an exposure equipment. The housing 1 can be used for isolation, storage or transport of the photomask unit 2. In this embodiment, the inlet 12 is connected to a gas-supplying device (not shown), by which the fresh cleaning gas is introduced into the outer chamber 11. The cleaning gas may be a nitrogen gas, clean dry air (CDA), extra clean dry air (XCDA), an inert gas, and so on. Besides, the outlet 13 is connected to a gas-removing device (not shown), by which the cleaning gas is discharged from the outer chamber 11. As such, the cleaning gas in the outer chamber 11 is in a circulation status.

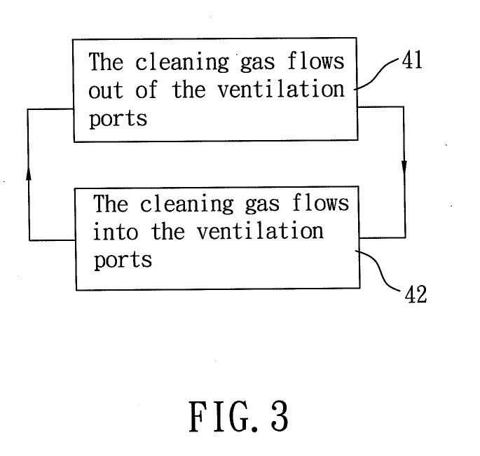

With further reference to FIGS. 3 to 5, the reduced-pressure generating unit 3 is disposed to intermittently generate a reduced-pressure zone 300 in the outer chamber 11 and in proximity to the photomask unit 2 such that a pressure differential is generated between the inner chamber 25 and the reduced-pressure zone 300 to cause the central film portion 231 to move toward or away from the central pattern region 212 so as to permit the cleaning gas to flow out of or into the ventilation ports 24 alternately.

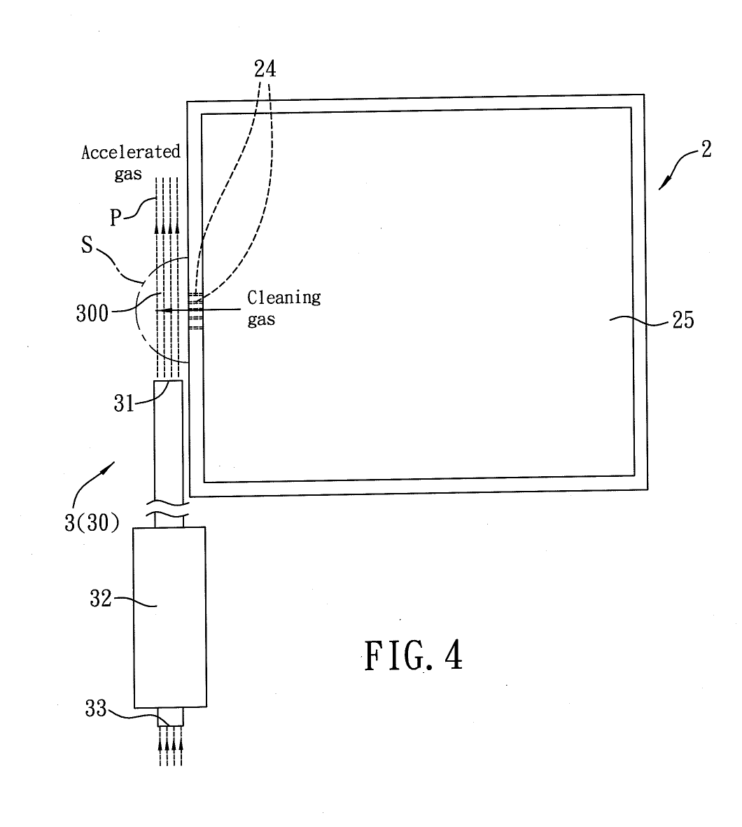

In this embodiment, the reduced-pressure zone 300 is generated in proximity to the ventilation ports 24 of the photomask unit 2 to permit the cleaning gas to flow out of the inner chamber 25. Beside, the reduced-pressure zone 300 is configured to cover the ventilation ports 24 and to extend radially from the ventilation port by up to 10 cm so as to define a dome-shaped space (S) (see FIG. 4). The reduced-pressure generating unit 3 is a flow accelerator 30 which is disposed to deliver an accelerated gas along a flow path (P) that is substantially parallel to the centerline (L), and that crosses the reduced-pressure zone 300. In other preferred embodiment, the flow path (P) of the accelerated gas may be delivered in any direction, as long as the accelerated gas does not flow into the inner chamber 25 through the ventilation ports 24, and as long as the accelerated gas crosses the dome-shaped space (S) to produce the reduced-pressure zone 300 in proximity to the ventilation ports 24. The accelerated gas may be the same as the cleaning gas, and may be a nitrogen gas, clean dry air (CDA), extra clean dry air (XCDA), an inert gas, and so on.

As best shown in FIGS. 2 and 4, the flow accelerator 30 has a gas outflowing port 31, a controller 32 for intermittently operating the flow accelerator 30, and a gas intake port 33. In this embodiment, the gas outflowing port 31 is oriented to face the reduced-pressure zone 300.

In a modified embodiment, the gas-supplying device (not shown) also functions as the flow accelerator, and has two gas outlet ports, one of which is communicated with the inlet 12 of the housing 1, and the other of which serves as the gas outflowing port 31 of the flow accelerator 30.

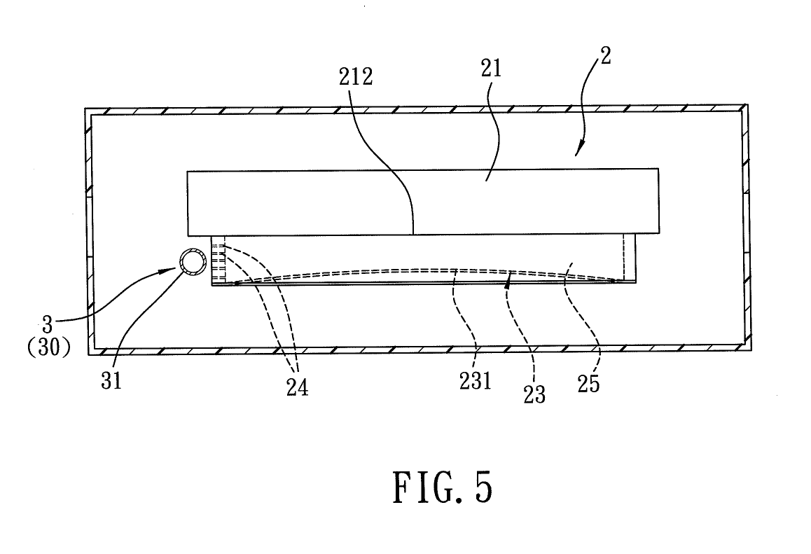

When the flow accelerator 30 is in an operation mode to deliver the accelerated gas (see FIGS. 4 and 5), the reduced-pressure zone 300 is generated based on Bernoulli's principle. At this moment, the pressure inside the inner chamber 25 is higher than that of the reduced-pressure zone 300 in the outer chamber 11, so that the cleaning gas in the inner chamber 25 flows out through the ventilation ports 24 into the outer chamber (see also step 41 in FIG. 3), and the central film portion 231 moves toward the central pattern region 212.

When the flow accelerator 30 is in a standby mode and stops delivering the accelerated gas (see FIGS. 1 and 2), the reduced-pressure zone 300 disappears, and the pressure inside the inner chamber 25 is lower than that in the outer chamber 11, so that the cleaning gas tends to flow into the inner chamber 25 through the ventilation ports 24 (see also step 42 in FIG. 3) until a pressure balance between the inner chamber 25 and the outer chamber 11 is achieved, and the central film portion 231 moves away from the central pattern region 212 and back to its original position.

Due to the intermittent generation of the reduced-pressure zone 300 in the outer chamber 11, the cleaning gas is permitted to flow out of or into the ventilation ports 24 alternately, thereby rapidly circulating the cleaning gas inside the inner chamber to effectively remove foreign substances from the inner chamber 25.

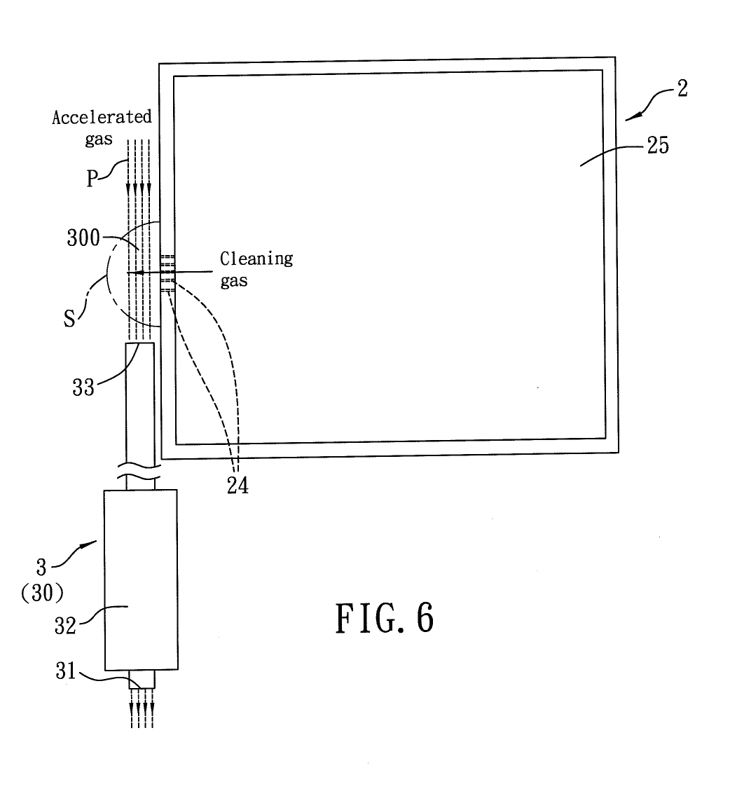

FIG. 6 illustrates the second preferred embodiment of a cleaning system for cleaning a photomask unit 2 according to this invention. The second preferred embodiment differs from the first preferred embodiment in that, in the second preferred embodiment, the gas intake port 33 is oriented to face the reduced-pressure zone 300.

In a modified embodiment, the gas-removing device functions as the flow accelerator, and has two gas inlet ports, one of which is connected to the outlet 13 of the housing 1 (see FIG. 1), and the other of which serves as the gas intake port 33 of the flow accelerator 30.

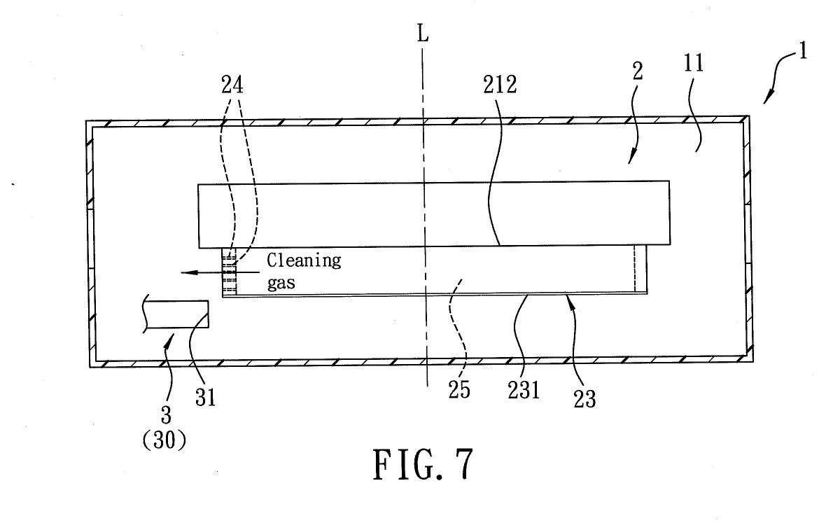

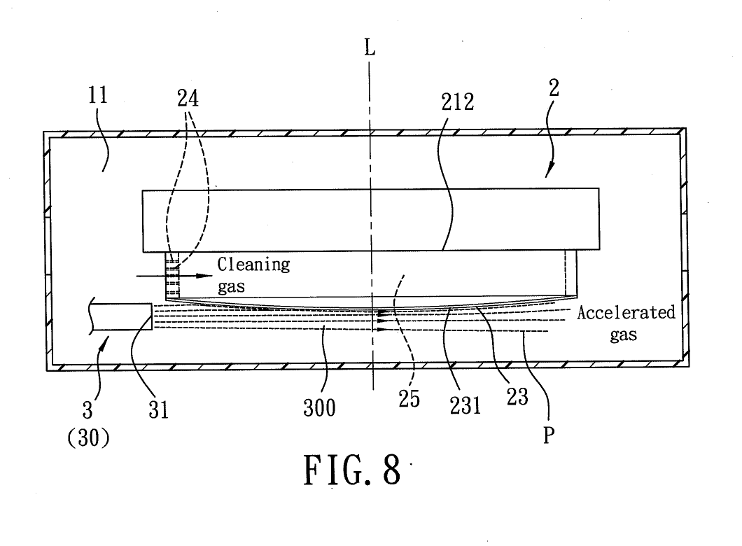

FIGS. 7 and 8 illustrate the third preferred embodiment of a cleaning system for cleaning a photomask unit 2 according to this invention. The third preferred embodiment differs from the first preferred embodiment in that, in the third preferred embodiment, the reduced-pressure zone 300 is generated in proximity to the diaphragm-like pellicle film 23 to permit the cleaning gas to flow into the inner chamber 25.

In detail, when the flow accelerator 30 is in an operation mode to deliver the accelerated gas along a flow path (P) that is transverse to the centerline (L) and that crosses the reduced-pressure zone 300 (see FIG. 8), the pressure inside the inner chamber 25 is higher than that of the reduced-pressure zone 300 in the outer chamber 11. Thus, the central film portion 231 is drawn to move away from the central pattern region 212. At this moment, the inner chamber 25 has an increased volume, and thus the cleaning gas in the outer chamber 11 is permitted to flow into the inner chamber 25 through the ventilation ports 24.

When the flow accelerator 30 is in a standby mode and stops delivering the accelerated gas (see FIG. 7), the reduced-pressure zone 300 disappears, and the central film portion 231 moves toward the central pattern region 212 and back to its original position. As such, the pressure inside the inner chamber 25 is higher than that in the outer chamber 11, and thus the cleaning gas tends to flow out of the inner chamber 25 through the ventilation ports 24 until a pressure balance between the inner chamber 25 and the outer chamber 11 is achieved.

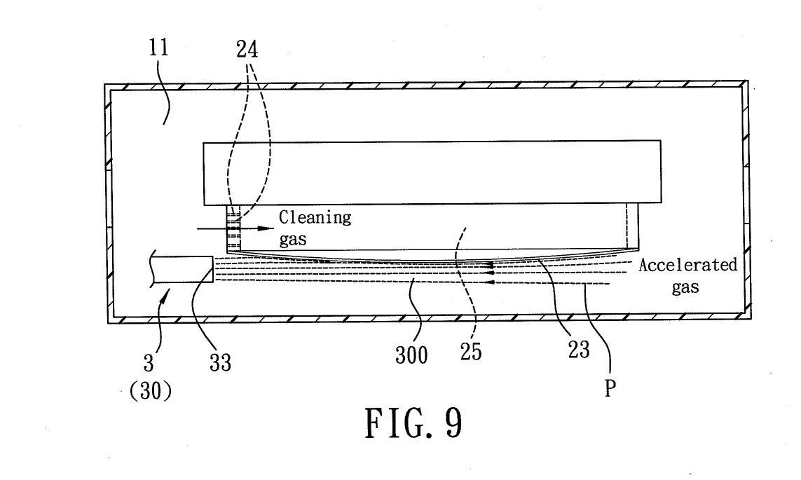

FIG. 9 illustrates the fourth preferred embodiment of a cleaning system for cleaning a photomask unit 2 according to this invention. The fourth preferred embodiment differs from the third preferred embodiment in that, in the fourth preferred embodiment, the gas intake port 33 is oriented to face the reduced-pressure zone 300.

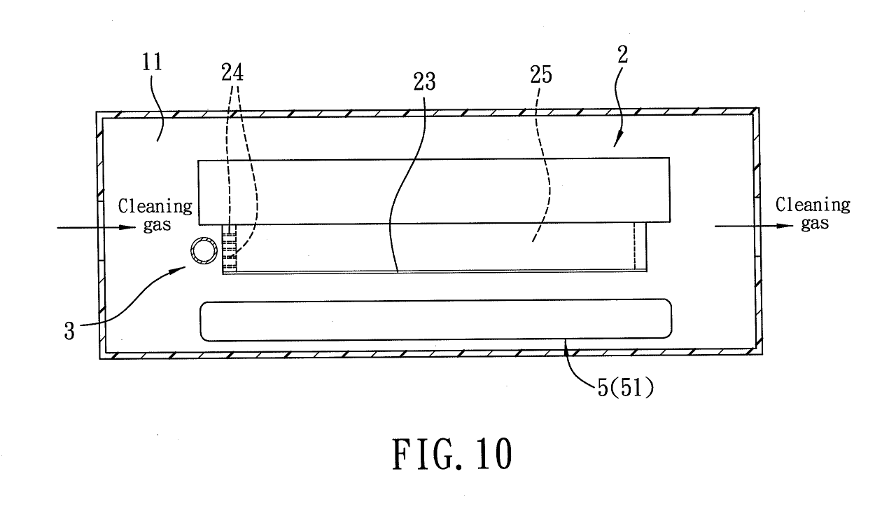

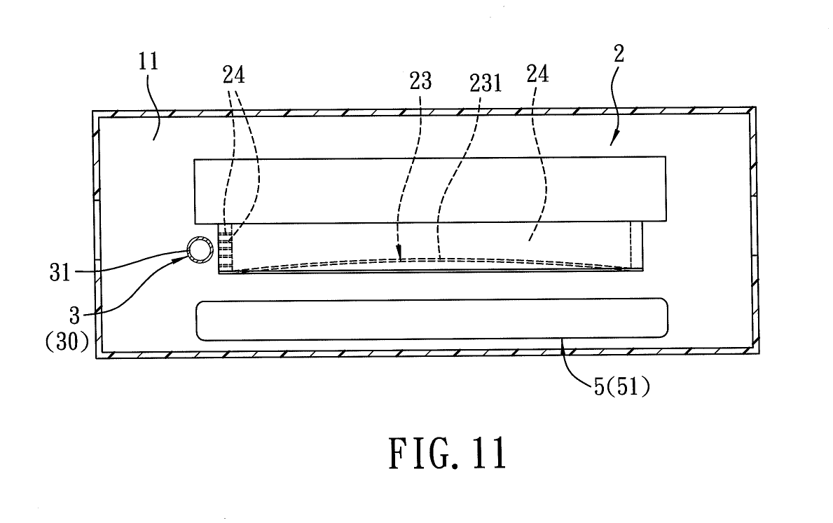

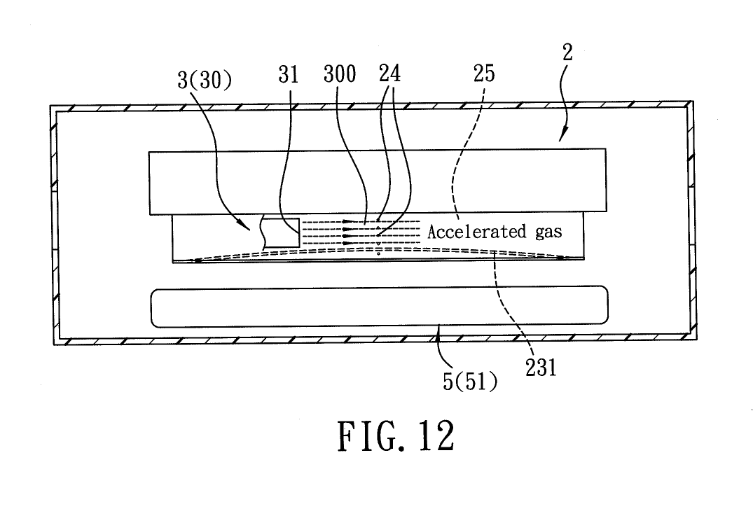

FIGS. 10 to 12 illustrate the fifth preferred embodiment of a cleaning system for cleaning a photomask unit 2 according to this invention. The fifth preferred embodiment differs from the first preferred embodiment in that, in the fifth preferred embodiment, the cleaning system further comprises a heating unit 5, such as a laser device, an IR device, a lamp, a thermocouple device, a hot plate, etc. The heating unit 5 is disposed to heat the cleaning gas in the inner chamber 25 intermittently and in synchronization with flow of the cleaning gas out of the inner chamber 25. Because the inner chamber 25 with the heated cleaning gas will have an increased pressure, the flow of the cleaning gas from the inner chamber 25 into the outer chamber 11 can be facilitated. Preferably, the cleaning gas in the inner chamber 25 is heated to a temperature ranging from 20° C. to 70° C. The heating unit 5 can be disposed at at least one of top and bottom sides of the photomask unit 2, thereby heating the photomask 21. In this embodiment, the heating unit 5 is disposed at the bottom side of the photomask unit 2.

In this embodiment, the heating unit 5 is a heating plate 51 disposed in proximity to the diaphragm-like pellicle film 23. It is noted that the heating unit 5 shown in FIGS. 10 to 12 is for purpose of exemplification only, and may be formed into various configurations or be disposed in any possible position to intermittently heat the cleaning gas in the inner chamber 25, and that it should not be limited to this embodiment. For example, the heating plate 51 may be replaced by multiple heating plates, or by one or multiple infrared tubes (not shown).

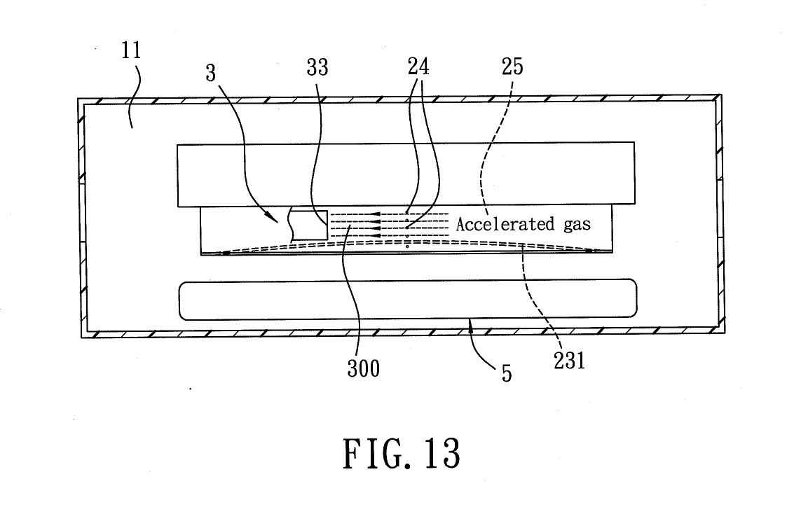

FIG. 13 illustrates the sixth preferred embodiment of a cleaning system for cleaning a photomask unit 2 according to this invention. The sixth preferred embodiment differs from the fifth preferred embodiment in that, in the sixth preferred embodiment, the gas intake port 33 is oriented to face the reduced-pressure zone 300.

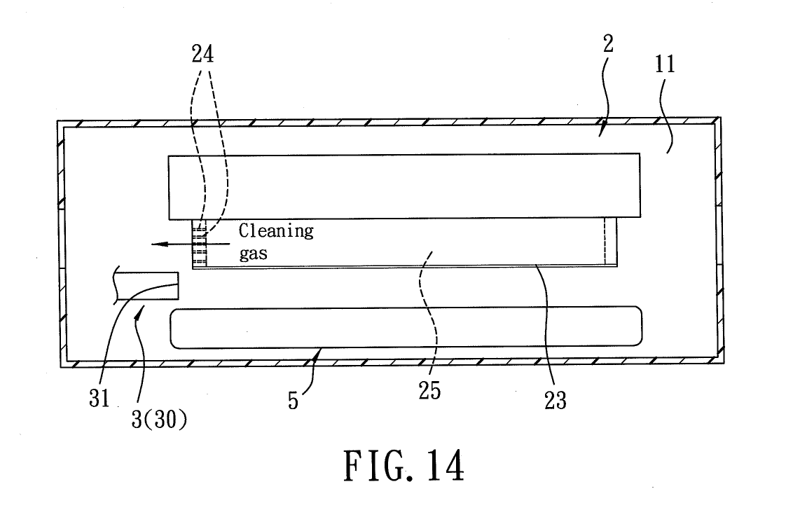

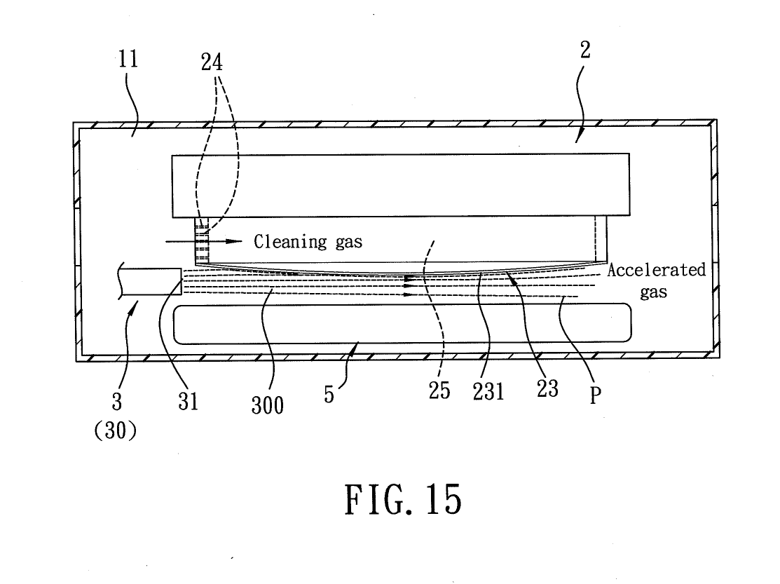

FIGS. 14 and 15 illustrate the seventh preferred embodiment of a cleaning system for cleaning a photomask unit 2 according to this invention. The seventh preferred embodiment differs from the third preferred embodiment in that the cleaning system in the seventh preferred embodiment further comprises the heating unit 5 disclosed in the sixth preferred embodiment.

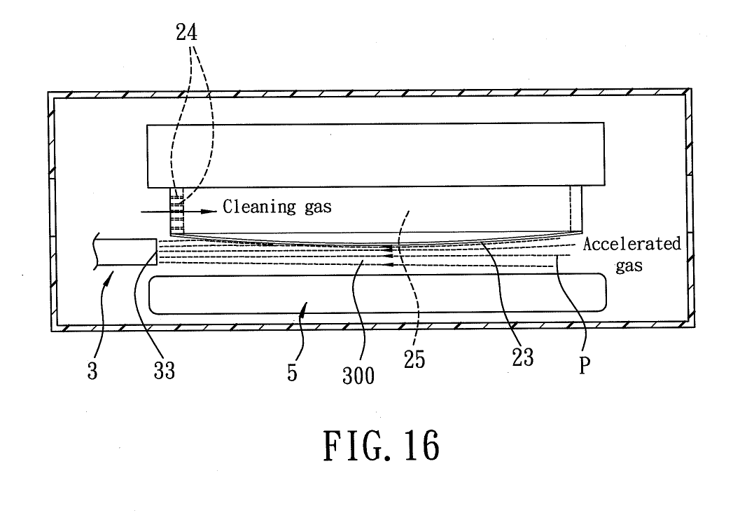

FIG. 16 illustrates the eighth preferred embodiment of a cleaning system for cleaning a photomask unit 2 according to this invention. The eighth preferred embodiment differs from the seventh preferred embodiment in that, in the eighth preferred embodiment, the gas intake port 33 is oriented to face the reduced-pressure zone 300.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A cleaning system for a photomask unit that includes:
a photomask having an inner major surface which has a central pattern region to be cleaned and an abutment region surrounding the central pattern region, and which defines a centerline to that the central pattern region is normal; a pellicle frame which surrounds the centerline and which extends from the abutment region along the centerline to terminate at a mounting end so as to define an inner chamber; a diaphragm-like pellicle film having a central film portion which extends in radial directions to terminate at a periphery that is connected to the mounting end, and which is configured to be movable toward or away from the central pattern region; and at least one ventilation port disposed in the pellicle frame to fluidly communicate with the inner chamber, said cleaning system comprising:
a housing defining an outer chamber configured to permit the photomask unit to be located therein, and having an inlet and an outlet to permit a cleaning gas to flow into and out of said outer chamber, respectively; and
a reduced-pressure generating unit disposed to intermittently generate a reduced-pressure zone in said outer chamber and in proximity to the photomask unit such that a pressure differential is generated between the inner chamber and said reduced-pressure zone to cause the central film portion to move toward or away from the central pattern region so as to permit the cleaning gas to flow out of or into the ventilation port alternately.

2. The cleaning system of claim 1, wherein said cleaning system includes at least two ventilation ports that are adjacent to each other.

3. The cleaning system of claim 1, wherein said reduced-pressure zone is generated in proximity to the ventilation port to permit the cleaning gas to flow out of the inner chamber.

4. The cleaning system of claim 3, wherein said reduced-pressure generating unit is a flow accelerator which is disposed to deliver an accelerated gas along a flow path that crosses said reduced-pressure zone.

5. The cleaning system of claim 4, wherein said flow path is substantially parallel to the centerline.

6. The cleaning system of claim 4, wherein said flow accelerator has a gas intake port and a gas outflowing port, said gas intake port being oriented to face said reduced-pressure zone.

7. The cleaning system of claim 4, wherein said flow accelerator has a gas intake port and a gas outflowing port, said gas outflowing port being oriented to face said reduced-pressure zone.

8. The cleaning system of claim 1, wherein said reduced-pressure zone is configured to cover the ventilation port and to extend radially from the ventilation port by up to 10 cm so as to define a dome-shaped space.

9. The cleaning system of claim 1, wherein said reduced-pressure zone is generated in proximity to the diaphragm-like pellicle film to permit the cleaning gas to flow into the inner chamber.

10. The cleaning system of claim 9, wherein said reduced-pressure generating unit is a flow accelerator which is disposed to deliver an accelerated gas along a flow path that is transverse to the centerline and that crosses said reduced-pressure zone.

11. The cleaning system of claim 10, wherein said flow accelerator has a gas intake port and a gas outflowing port, said gas intake port being oriented to face said reduced-pressure zone.

12. The cleaning system of claim 10, wherein said flow accelerator has a gas intake port and a gas outflowing port, said gas outflowing port being oriented to face said reduced-pressure zone.

13. The cleaning system of claim 1, further comprising a heating unit disposed to heat the cleaning gas in the inner chamber intermittently.

14. The cleaning system of claim 13, wherein said heating unit is operated in synchronization with flow of the cleaning gas out of the inner chamber so as to facilitate flow of the cleaning gas from the inner chamber into said outer chamber.

15. The cleaning system of claim 13, wherein said heating unit is disposed at least one of top and bottom sides of the photomask unit.

16. The cleaning system of claim 13, wherein said heating unit is selected from a group consisting of a heating plate, an infrared tube, a laser device, an IR device, a lamp, a thermocouple device, and a hot plate.

17. A method for cleaning a photomask unit that includes:
a photomask having an inner major surface which has a central pattern region to be cleaned, and which defines a centerline to that the central pattern region is normal; a pellicle frame extending from the photomask to surround the centerline and to terminate at a mounting end so as to define an inner chamber; a diaphragm-like pellicle film having a central film portion and a periphery that surrounds the central film portion and that is connected to the mounting end; and at least one ventilation port disposed in the pellicle frame to fluidly communicate with the inner chamber, the method comprising:
mounting the photomask unit in an outer chamber of a housing, the housing having an inlet and an outlet to permit a cleaning gas to flow into and out of the outer chamber, respectively; and
intermittently generating a reduced-pressure zone in the outer chamber and in proximity to the photomask unit such that a pressure differential is generated between the inner chamber and the reduced-pressure zone to cause the central film portion to move toward or away from the photomask so as to permit the cleaning gas to flow out of or into the ventilation port alternately.

18. The method of claim 17, wherein the reduced-pressure zone is generated in proximity to the ventilation port to permit the cleaning gas to flow out of the inner chamber.

19. The method of claim 18, wherein the reduced-pressure zone is generated by delivering an accelerated gas.

20. The method of claim 17, wherein the reduced-pressure zone is generated in proximity to the diaphragm-like pellicle film to permit the cleaning gas to flow into the inner chamber.

21. The method of claim 20, wherein the reduced-pressure zone is generated by delivering an accelerated gas along a flow path that is transverse to the centerline.

22. The method of claim 19, further comprising a step of heating the photomask unit intermittently.

23. The method of claim 22, wherein the step of heating the photomask unit is implemented in synchronization with flow of the cleaning gas out of the inner chamber so as to facilitate flow of the cleaning gas from the inner chamber into the outer chamber.

24. The method of claim 23, wherein the cleaning gas in the inner chamber is heated to a temperature ranging from 20° C. to 70° C. while heating the photomask unit.
